(19) United States
(12) Patent Application Publication
(10) Pub. No.: US 2025/0335187 A1
(43) Pub. Date: Oct. 30, 2025

(54) SCOPE INHERITANCE AND MODIFIERS FOR A CENTRAL TEXT REPOSITORY

(71) Applicant: Oracle International Corporation, Redwood Shores, CA (US)

(72) Inventors: Simon Clark, Guelph (CA); Tanya Marie Chapman, Elora (CA)

(73) Assignee: Oracle International Corporation, Redwood Shores, CA (US)

(21) Appl. No.: 18/649,012

(22) Filed: Apr. 29, 2024

(51) Int. Cl. G06F 8/71; G06F 40/58

(52) U.S. Cl. CPC G06F 8/71; G06F 40/58

(57) ABSTRACT

A central text repository may maintain, track, update, and modify text centrally that may then be distributed to applications to be used at runtime. The central text repository allows anyone involved in the software design processor lifecycle to edit, update, and/or correct text strings that are used in various applications. This allows updates to be rapidly pushed out to runtime applications without requiring the codes bases of those applications to be accessed at all. Instead, a change may be made centrally, and new resource bundles of text strings may be made available for runtime downloading usage by these applications. This effectively separates the storage and maintenance of text strings from the underlying applications. Hierarchies and modifiers may be used to override and inherit different text usages, languages, and so forth.

### BACKGROUND

User interfaces have evolved significantly since the advent of computing systems. Text-based interfaces represent one of the fundamental modes of interaction, allowing users to input commands and receive feedback through textual representations. From early command-line interfaces to modern graphical user interfaces (GUIs), text has remained a cornerstone in facilitating human-computer interaction. Despite the proliferation of multimedia and voice-based interfaces, text-based interactions persist due to their efficiency, universality, and ease of implementation across diverse platforms and devices.

Traditional text interfaces, while effective, often lack the ability to adapt dynamically to user preferences and contextual information. Static text displays may present challenges in conveying complex information or engaging users effectively. Moreover, with the rise of mobile and touchscreen devices, the constraints of screen real estate pose additional challenges in presenting textual content in a clear and concise manner. As users increasingly demand personalized and intuitive experiences, there is a growing need for text-based interfaces that can intelligently adapt to individual preferences, device characteristics, and contextual factors.

### SUMMARY

This disclosure describes a central text repository that maintains, tracks, updates, and modifies text centrally that may then be distributed to applications to be used at runtime. The central text repository allows anyone involved in the software design processor lifecycle to edit, update, and/or correct text strings that are used in various applications. This allows updates to be rapidly pushed out to runtime applications without requiring the codes bases of those applications to be accessed at all. Instead, a change may be made centrally, and new resource bundles of text strings may be made available for runtime downloading usage by these applications. This effectively separates the storage and maintenance of text strings from the underlying applications.

The central text repository may represent text using a data structure that includes a string key identifying the string and a value that stores the actual string text or content. These string keys may be subdivided into scopes that are associated with different contexts in the application. For example, a particular user interface in the application may be considered a context, and the central text repository may maintain a scope container that corresponds to this context. Like the contexts or user interfaces of the application, the scopes may be organized in a hierarchy of parent-child relationships. Each of these string keys may store a link to any scope that uses that string key. Therefore, a scope may identify all of the string keys that are needed to run in a particular context in the application. For example, a first hierarchy may be used to inherit string keys from parent scopes, which allows string keys to be overridden by child scopes. For example, the text on a cancel button in a parent window may be changed by the child window by adding an overriding string key within the child scope. These parent-child relationships in the hierarchy may be organized such that only the string keys actually used by each context are pushed out to the context. This greatly reduces the size of these text files and the bandwidth required to download them at runtime.

The scopes at the central text repository may also be organized in a second hierarchy. In contrast to the first hierarchy, the parent-child relationships in the second hierarchy may be language based. For example, text strings in a child scope may include strings in a specific language. The language translations may be used to override other translations for certain text strings. For example, a parent scope for the application may use a particular language, while a child scope inheriting from the parent scope may override certain text strings to conform to a local dialect. The central text repository may traverse the second hierarchy and select strings with the proper translation automatically based on the associated context.

Instead of simply returning a central text string value for each string key, some embodiments may also incorporate modifiers into the data structures. Modifiers may include different forms or usages of the text string. When a string key is provided, the corresponding value may include an array of string values with associated modifiers. The application may then parse the modifiers to match a requirement at the application and select a closest match of the modifiers and the associated text string.

In order to provide runtime text strings to remote applications without a significant delay, the central text repository may generate resource bundles that include all of the text strings for a specific context. This may be generated as a static file that is uploaded to a content delivery network (CDN) or other distribution network. The CDN may cache local copies where the application is running. At runtime, the application can download the latest version of the resource bundle and populate the string content within the application using text from the resource bundle. When text is updated at the central text repository, a new resource bundle may be generated for each affected exportable scope and uploaded to the CDN to replace existing resource bundles with the updated versions.

### BRIEF DESCRIPTION OF THE DRAWINGS

A further understanding of the nature and advantages of various embodiments may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a block diagram of a system that implements a central text repository, according to some embodiments.

FIG. 2 illustrates a flowchart of a method for using a central text repository to generate resource bundles of text strings for applications, according some embodiments.

FIG. 3 illustrates contexts in the application and scopes as organized by the central text repository, according some embodiments.

FIG. 4 illustrates multiple hierarchies that may be present in the scope data structure 320, according to some embodiments.

FIG. 5 illustrates a logical diagram of how string keys may be related to other data structures in the central text repository, according to some embodiments.

FIG. 6 illustrates sample pseudocode for a routine executed by the central text repository for generating a resource bundle, according to some embodiments.

FIG. 7 illustrates a diagram of a content delivery network for delivering resource bundles from the central text repository to the application, according to some embodiments.

FIG. 8 illustrates a string key data structure that includes modifiers for the string text, according to some embodiments.

FIG. 9 illustrates a simplified block diagram of a distributed system for implementing some of the embodiments.

FIG. 10 illustrates a simplified block diagram of components of a system environment by which services provided by the components of an embodiment system may be offered as cloud services.

FIG. 11 illustrates an exemplary computer system, in which various embodiments may be implemented.

### DETAILED DESCRIPTION

Delivering quality textual content (e.g., text strings) to an application is not currently a seamless process, and it often requires a high level of manual human interaction. For example, web applications, desktop applications, mobile applications, cloud-hosted applications, and/or any other type of application may be made available that includes text presented in the user interface. For example, interface controls, notifications, tips, toolbars, menu items, and/or any other element of a user interface may include text that is presented to the user as part of the application, as opposed to text that is entered by the user into the application. As applications are deployed in different operating environments, in different cultures, in different countries, and in different languages, managing text embedded in these applications is becoming a more important aspect of the application lifecycle. Users tend to have a better experience with a product when they feel that the product was designed and made specifically for their circumstances, rather than being made in a foreign environment and merely being adapted for local use. When text can be localized for particular users, it allows for the use of local idioms, colloquialisms, and other language forms that are difficult to universally apply.

When text needs to change globally, this process can be very difficult when that text is located in multiple applications or multiple versions of an application that are simultaneously deployed in different environments. For example, if a typographical error is detected in the text presented on the user interface, correcting this error can take months of processing time and many hours of individual user effort to correct the text. This problem largely results from the fact that the text presented in the user interface is often embedded in the code base for the application. Additionally, much of the text that is used in various applications is reused over and over again in separate instances. This requires separately storing multiple copies of a text string in the code bases for different applications. This system typically does not allow for the text to be reused across multiple applications. Even if text can be reused, the system does not allow existing text to be overridden on a case-by-case basis when alterations are needed for particular applications. As a specific example, a single concept may be expressed in a single language in many different ways, and each of those expressions may be translated into multiple languages, with each language translation including multiple possible forms.

The embodiments described herein solve these and other technical problems by separating the system for maintaining and delivering text to applications from the applications themselves. Specifically, the system functions separately to manage, translate, track, and maintain quality of the displayed text in applications. The central text repository allows anyone involved in the software design processor lifecycle to edit, update, and/or correct text strings that are used in various applications. This allows updates to be rapidly pushed out to runtime applications without requiring the codes bases of those applications to be accessed at all. Instead, a change may be made centrally, and new resource bundles of text strings may be made available for runtime downloading usage by these applications. This effectively separates the storage and maintenance of text strings from the underlying applications.

The central text repository may represent text using a data structure that includes a string key identifying the string and a value that stores the actual string text or content. These string keys may be subdivided into scopes that are associated with different contexts in the application. For example, a particular user interface in the application may be considered a context, and the central text repository may maintain a scope container that corresponds to this context. Like the contexts or user interfaces of the application, the scopes may be organized in a hierarchy of parent-child relationships. Each of these string keys may store a link to any scope that uses that string key. Therefore, a scope may identify all of the string keys that are needed to run in a particular context in the application. For example, a first hierarchy may be used to inherit string keys from parent scopes, which allows string keys to be overridden by child scopes. For example, the text on a cancel button in a parent window may be changed by the child window by adding an overriding string key within the child scope. These parent-child relationships in the hierarchy may be organized such that only the string keys actually used by each context are pushed out to the context. This greatly reduces the size of these text files and the bandwidth required to download them at runtime.

The scopes at the central text repository may also be organized in a second hierarchy. In contrast to the first hierarchy, the parent-child relationships in the second hierarchy may be language based. For example, text strings in a child scope may include strings in a specific language. The language translations may be used to override other translations for certain text strings. For example, a parent scope for the application may use a particular language, while a child scope inheriting from the parent scope may override certain text strings to conform to a local dialect. The central text repository may traverse the second hierarchy and select strings with the proper translation automatically based on the associated context.

Instead of simply returning a central text string value for each string key, some embodiments may also incorporate modifiers into the data structures. Modifiers may include different forms or usages of the text string. When a string key is provided, the corresponding value may include an array of string values with associated modifiers. The application may then parse the modifiers to match a requirement at the application and select a closest match of the modifiers and the associated text string.

In order to provide runtime text strings to remote applications without a significant delay, the central text repository may generate resource bundles that include all of the text strings for a specific context. This may be generated as a static file that is uploaded to a content delivery network (CDN) or other distribution network. The CDN may cache local copies where the application is running. At runtime, the application can download the latest version of the resource bundle and populate the string content within the application using text from the resource bundle. When text is updated at the central text repository, a new resource bundle may be generated for each affected exportable scope and uploaded to the CDN to replace existing resource bundles with the updated versions.

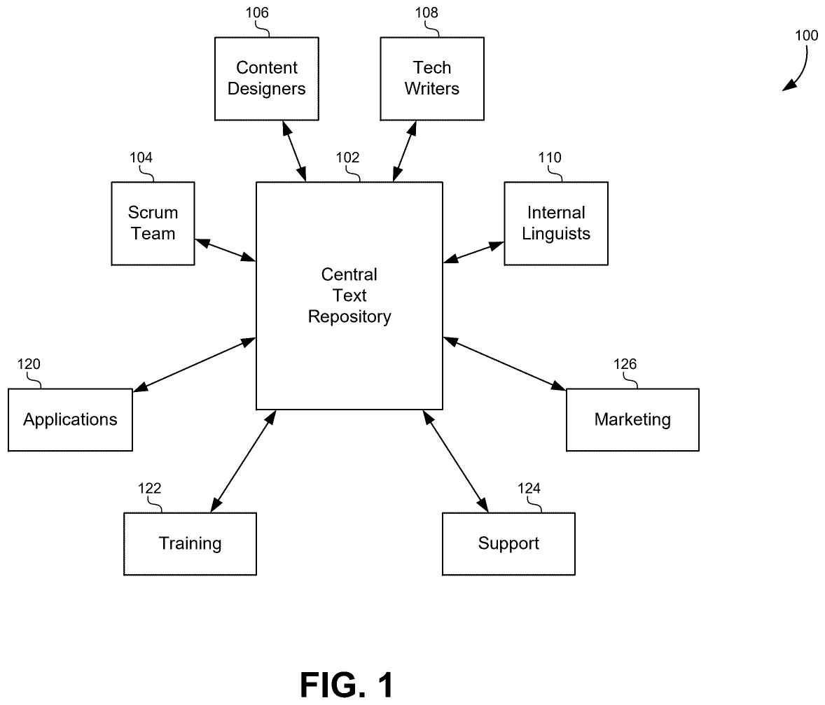

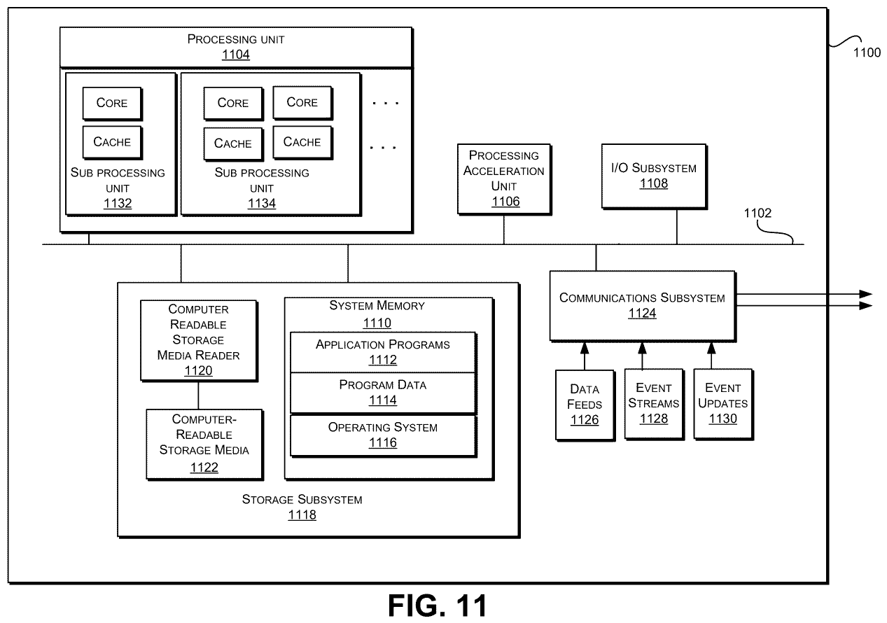

FIG. 1 illustrates a block diagram of a system 100 that implements a central text repository 102, according to some embodiments. The central text repository 102 may be implemented using a computing system. For example, the central text repository may be implemented using the computer system 1100 illustrated below in FIG. 11. Specifically, one more processors may be used to execute instructions stored on one or more memory devices. These memory devices may include one or more non-transitory computer-readable media configured to store computer instructions. When executed by the one or more processors, the instructions may cause the one or more processors to perform the operations described below. The processors and/or the memory devices may be co-located in a single computing system. Alternatively, the processors and/or the memory devices may be distributed either logically or geographically in a plurality of different computing systems. For example, some of the instructions may be executed by a cloud-based server, while another portion of the instructions may be executed by a mobile application. Any and/or all of these different configurations are compatible with the central text repository 102.

FIG. 1 illustrates how various entities may interact with the central text repository 102. These different entities may provide text to the central text repository 102 and/or consume text from the central text repository 102. For example, various entities involved in developing and maintaining the application during the application lifecycle may provide updates to the text stored in the central text repository 102. These entities may include scrum teams 104, content designers 106, technical writers 108, and/or internal linguists 110, among other entities not explicitly listed. These entities typically provide text to the central text repository 102 to be integrated as part of the applications 120 when presented to users. The interface provided by the central text repository 102 allows any of these different entities to edit, update, or otherwise maintain the text strings stored in the central text repository 102. This may be contrasted with previous solutions where, for example, a language specialist would see a problem with text displayed in a user interface in a particular language translation. A correction would need to be propagated to the content designers 106 and/or the technical writers 108. The code executed by each version of the applications 120 would then need to be individually corrected and pushed out to the different computing environments. The central text repository 102 solves this technical problem by allowing the text to be updated in a central location by any approved entities.

Additionally, the central text repository 102 may provide text to various versions of the applications 120. As described in detail below, applications may execute in different computing environments that may have different text requirements. For example, applications may operate in different geographic environments, such as different countries, different regions, or different areas with individual language dialects. Instead of generating multiple versions of the application, the central text repository 102 can provide individual text strings to each of these different operating environments to customize the user experience based on those environments. For example, the override and modifier features of the central text repository 102 described below may be used by the application at runtime to populate fields in the user interface with different versions of the text based on the location.

The different computing environments of the applications 120 may be characterized by more than just geographic location. For example, different computing environments may also include different operating systems, different runtime environments, different apps installed with the application, different features being enabled, different stages of use within the application, and so forth. Based on any of these runtime factors, the application may request a different resource bundle from the central text repository to accommodate the runtime text needs of the application. Alternatively, modifiers may be used in an existing resource bundle to select between different available string options by the application.

In addition to providing text to the applications 120, the central text repository may also provide text for training teams 122, support teams 124, and/or marketing teams 126. Each of these entities may request a resource bundle from the central text repository 102 that may include portions of the text displayed in the user interfaces for training, support, and marketing purposes. Any of these entities may also request changes to the text as needed through the interface of the central text repository 100 to as described above.

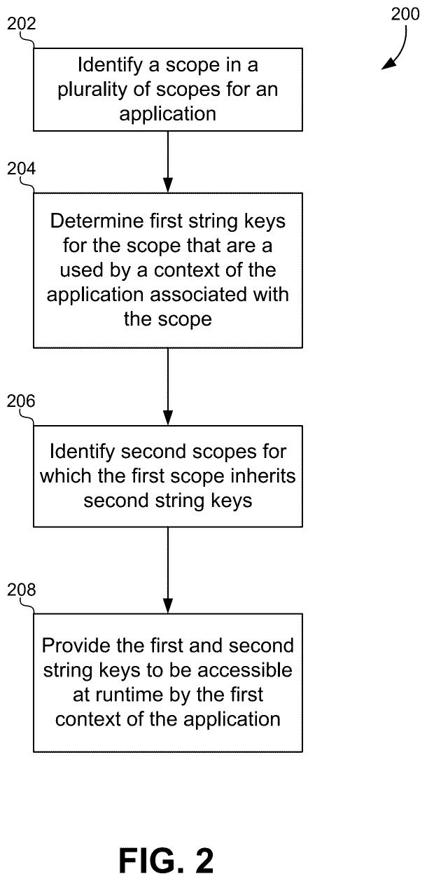

FIG. 2 illustrates a flowchart of a method 200 for using a central text repository to generate resource bundles of text strings for applications, according some embodiments. The operations of the method 200 may be carried out by a computer system, such as the central text repository 102 described above. The method 200 may include identifying a first scope in a plurality of scopes for an application (202). The plurality of scopes may be organized in a first hierarchy of parent-child relationships, and each of the plurality of scopes may be associated with different contexts of the application.

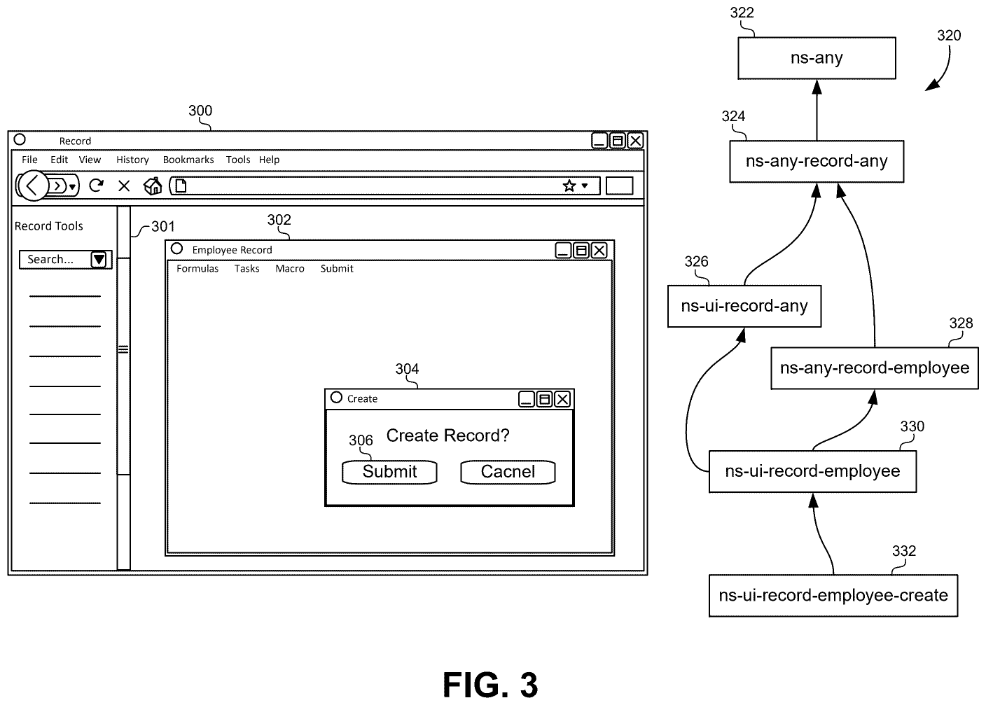

FIG. 3 illustrates contexts in the application and scopes as organized by the central text repository, according some embodiments. An application may be organized into a plurality of “contexts.” Each of the contexts may represent a specific aspect of the application. For example, a context may represent a particular user interface or portion of a user interface in the application. These contexts may be organized in a hierarchy of parent-child relationships. In the example of FIG. 3, the top-level user interface 300 may represent a top-level context of the application. The top-level user interface 300 may include a number of child containers or child user interfaces that would operate inside of the top-level user interface 300. For example, the top-level user interface 300 may include child contexts of the search and navigation interface 301 as well as the employee record interface 302. Additionally, the employee record interface 302 may include the create employee interface 304 (e.g., a modal pop-up window), and so forth.

Note that contexts may be directly related in a one-to-one relationship to user interface elements of the application in some embodiments. Alternatively, other applications may include groups of user interfaces, or other groupings of user experiences as contexts. For example, a context may include a progression of web forms or user interfaces presented to a user. These embodiments also include non-graphical user interfaces, such as audio interfaces. For example, a digital home assistant may operate through a speaker output and a voice command interface. The audio output of the digital home assistant may be analogous to the graphical user interfaces described in FIG. 3, and the contexts may include different portions of interactions with the user. Instead of presenting text on the screen, the digital home assistant may verbally communicate the text to the user. In addition to audio interfaces, other portions of the user experience may also be included as contexts, including but not limited to hand gestures, hand motions, eyes motions/inputs, and/or any other type of user interface.

The contexts of the application may be related to scopes stored at the central text repository. Scopes may be implemented as containers in a data structure 320. The scopes may be organized into a hierarchy that includes parent-child relationships. Generally, at least one scope may be associated with each context in the user interface. However, more than one scope may be associated with a particular context, and a scope may be associated with multiple contexts. Note that the data structure 320 is greatly simplified and only a subset of the available scopes for the user interface illustrated in FIG. 3 are present for the sake of clarity.

In this example, the data structure 320 may include a top-level scope 322 that may be associated with any of the other scopes (and optionally any of the contexts of the user interface). Child scopes may include a scope 324 specifically related to any type of record in the system. Child scopes of the records scope 324 may include a scope 326 for the user interface of any record and/or a scope 328 for any type of employee record. Traversing further down the hierarchy of the data structure 320, a scope 330 related to the user interface for any employee record may be a child of both of scope 326 and scope 328. Finally, a scope 332 for creating a new employee record may be a child of scope 330.

Generally, a context of the application may be associated with at least one of the scopes in the data structure 320. For example, the create employee interface 304 may be associated with the scope 332 in the data structure 320. In some embodiments, a request may be received to generate a resource bundle of text strings for a particular context. Therefore, a request may be received that identifies a particular context, and the central text repository may then identify a scope that is associated with that context and generate the corresponding resource bundle. Alternatively, a particular scope may be identified when a text string has changed. As described below, text strings may be stored in string key data structures that may store links to any scopes that are associated with those string keys. When a string key is changed, the system may identify all scopes that are associated with that string key and then generate new corresponding resource bundles that reflect the change. In some embodiments, scopes may have a plurality of attributes. These attributes may include a name, a list of other scopes from which this scope inherits string keys, scopes for which translations may be inherited, and so forth. One attribute may include an “exportable” attribute that indicates that a resource bundle from the scope should be exported. Therefore, some embodiments may identify a particular scope by identifying scopes in the data structure 320 that have an “exportable” attribute value.

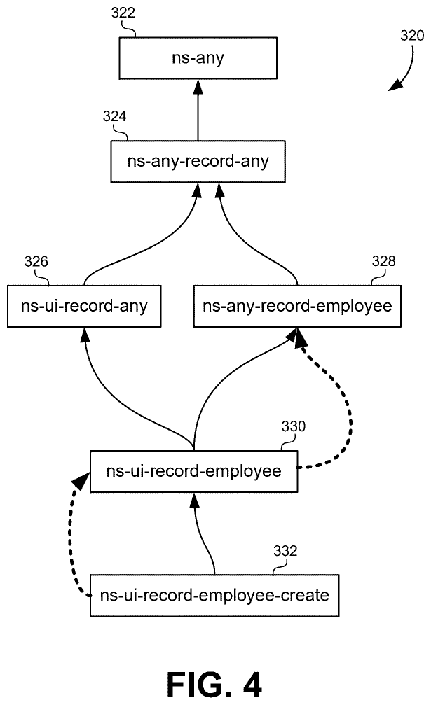

Turning back to FIG. 2, the method 200 may also include determining one or more first string keys for the first scope that are a used by a first context of the application associated with the first scope (204). FIG. 4 illustrates multiple hierarchies that may be present in the scope data structure 320, according to some embodiments. These different hierarchies may be referred to as “first” and “second” hierarchies only to distinguish these two elements from each other. However, the terms first/second are not meant to convey any other meeting, including order, importance, and so forth.

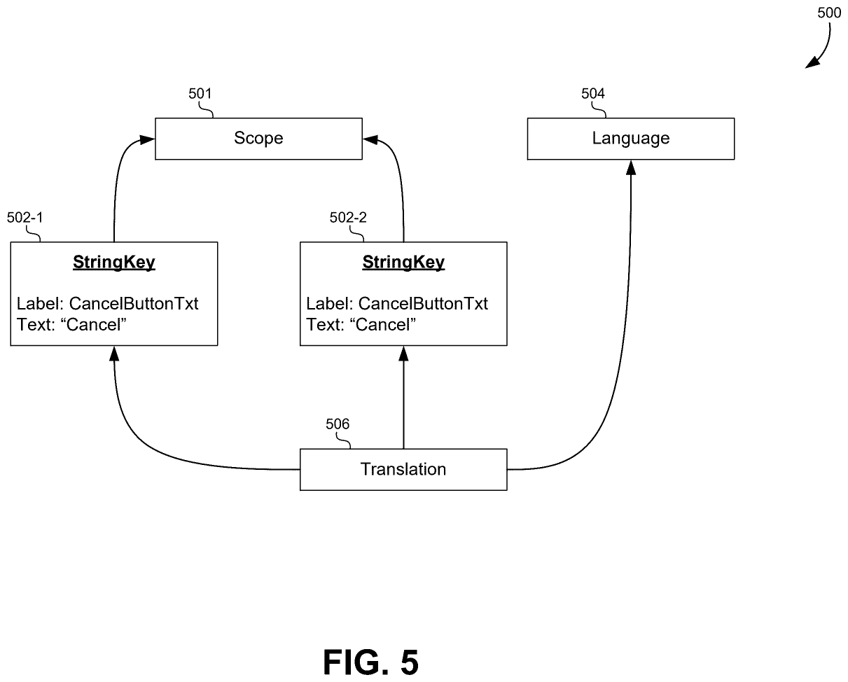

A first hierarchy may be denoted by the dashed lines in FIG. 4. This first hierarchy may be used to represent a relationship indicating that a child scope should inherit all string keys from a parent scope. For example, scope 332 may be referenced by one or more string keys that are used by the corresponding context of the application. The string keys for a particular scope may be referred to as one or more “first” string keys. FIG. 5 illustrates a logical diagram 500 of how string keys may be related to other data structures in the central text repository, according to some embodiments. Each string key may be represented by a data structure that stores information for a string. The string key itself may be considered a label for the corresponding string that may be referenced by the application code. For example, the string key “CancelButtonTxt” may be referred to by the user interface code of the application, and this labeled may be embedded as part of the source code for an application. This allows the application to reference the string key without hard coding in the actual string values, which may be inherited, overwritten, and/or modified as described herein based on the attributes of the application being run.

In its simplest form, a string key may also include a text value that defines the actual string to be displayed by the application. For example, the string key for the “CancelButtonTxt” may include a value text string such as “Cancel.” This may represent text that should be displayed on the cancel button in the user interface when this string key is referenced by the code. As described below, a string key may also include an array of strings that represent modifications to the string that may be selected by the application at runtime.

The string keys 502 may be associated with one or more scopes. For example, the string keys 502 may store a list of links that reference a scope 501 in the data structure. Additionally, particular translations 506 may reference one or more of the string keys 502. A translation 506 may in turn reference a language 504. For example, a translation 506 may represent translations of strings into a German language 504. When a particular translation is selected, particular string keys for that translation may also be selected.

In order to identify, determine, or select the one or more first string keys for a selected scope 501 in the database, the relationships depicted in FIG. 5 may be traversed. For example, if the scope 501 is the selected scope (e.g., the text associated with the scope 501 has changed, the scope 501 is marked as exportable, etc.), then the central text repository may identify any string keys 502 that reference the selected scope 501. These string keys may be used by the context associated with the scope 501 in the application, such as a particular user interface that includes a cancel button.

The method 200 may also include identifying one or more second scopes in the plurality of scopes for which the first scope inherits one or more second string keys (206). The first hierarchy depicted by the dashed lines in FIG. 4 may now be traversed in order to identify any parent scopes with string keys that should be inherited by the current scope. For example, if scope 332 is the identified first scope for which the resource bundle is being generated, the central text repository may traverse the data structure 332 and also include any of the string keys associated with scope 330 and scope 328. These additional string keys may be referred to as one or more “second” string keys that are sourced from parent scopes in the data structure 320.

String keys may be inherited and/or overridden based on the inheritance relationships in the data structure 320. For example, the scope 328 for an employee record may include a string key for a cancel button. If the scope 332 also uses this cancel button, a new string key does not need to be defined for the scope 332. Instead, the scope 332 can simply inherit that string key for the cancel button from the scope 328 through the inheritance relationship. Alternatively, the scope 332 may define a new string key for a cancel button that is different from the cancel button in the scope 328. This cancel button string key may override the string key that references the scope 328. This allows content designers a great deal of flexibility when customizing a user interface without storing each string of text individually when used repeatedly.

In FIG. 4, a second hierarchy of parent-child relationships may also be present in the data structure 320. The second hierarchy may be represented by the solid lines in FIG. 4. The solid lines may represent scopes for which translations may be sourced. As illustrated in FIG. 5, string keys may be linked with translations and languages. For example, when generating a resource bundle, a particular language and/or translation may be identified. String keys may be associated with individual languages/translations. In addition to selecting string keys that are associated with the scope according to the first hierarchy, some embodiments may also select string keys that are referenced by a particular language/translation. For example, a translation for each of the string keys for each scope traversed through the first hierarchy may also be identified by traversing the second hierarchy. This allows resource bundles to be generated that include specific languages/translations for strings.

The first hierarchy represented by the dashed lines need not traverse the entire set of scopes up to a root scope. Specifically, when traversing the first hierarchy of parent-child relationships (i.e., the dashed lines), the system does not necessarily reach a root scope of the second hierarchy (i.e., the solid lines). As illustrated in FIG. 4, only two generations of scopes are traversed when selecting scope 332. This allows the resource bundles of text strings to be relatively small. Instead of storing resource bundles for an entire application, resource bundles may be exported that include only string keys that are necessary for a particular context. This allows the resource bundles to be relatively small and lightweight, which reduces the bandwidth required to transmit these resource bundles at runtime and reduces the memory requirements to store these resource bundles in a content delivery network.

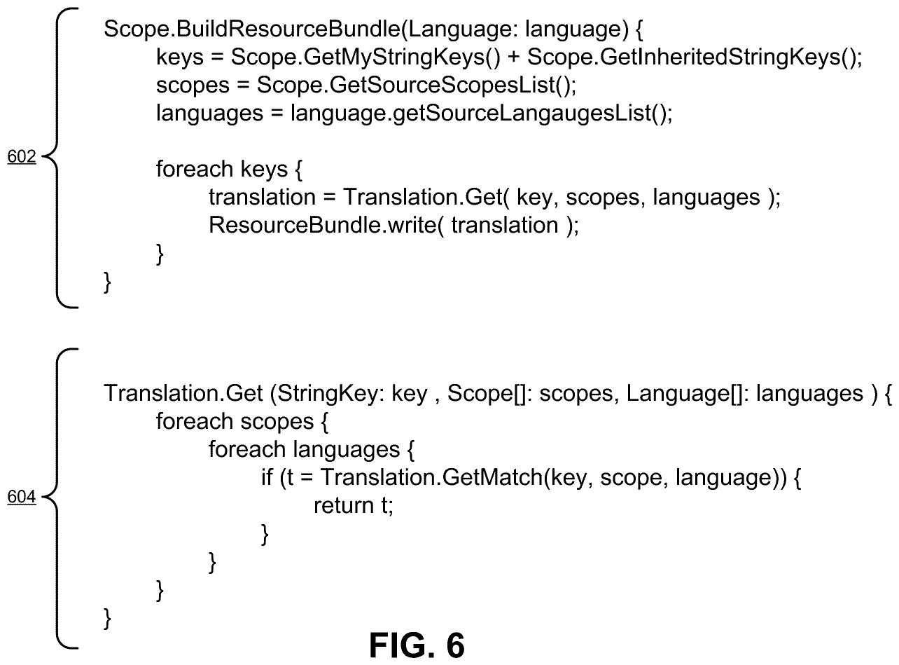

FIG. 6 illustrates sample pseudocode for a routine executed by the central text repository for generating a resource bundle, according to some embodiments. A “resource bundle” may include all of the string keys used by a particular context. The resource bundle may be generated by the central text repository and made available to applications to access at runtime. The pseudocode may include a first routine 602 that builds a resource bundle from the scope data structure. A selected scope may receive a selected language as a parameter. Next, the set of string keys may be assembled by requesting all string keys that reference the current scope with GetMyStringKeys (the one or more first string keys) along with the string keys that reference parent scopes with GetMyInheritedKeys (the one or more second string keys). These may be identified by traversing the first hierarchy as described above. Finally, for each of the assembled first and second string keys, the routine 602 may identify a translation for each string key by traversing the first hierarchy as described above. This effectively retrieves any specific languages that this resource bundle should be sourced from. Specifically, routine 604 may traverse the first hierarchy and retrieve a translation, falling back on languages first, then on each individual scope. This allows both languages and text strings to be overridden as needed.

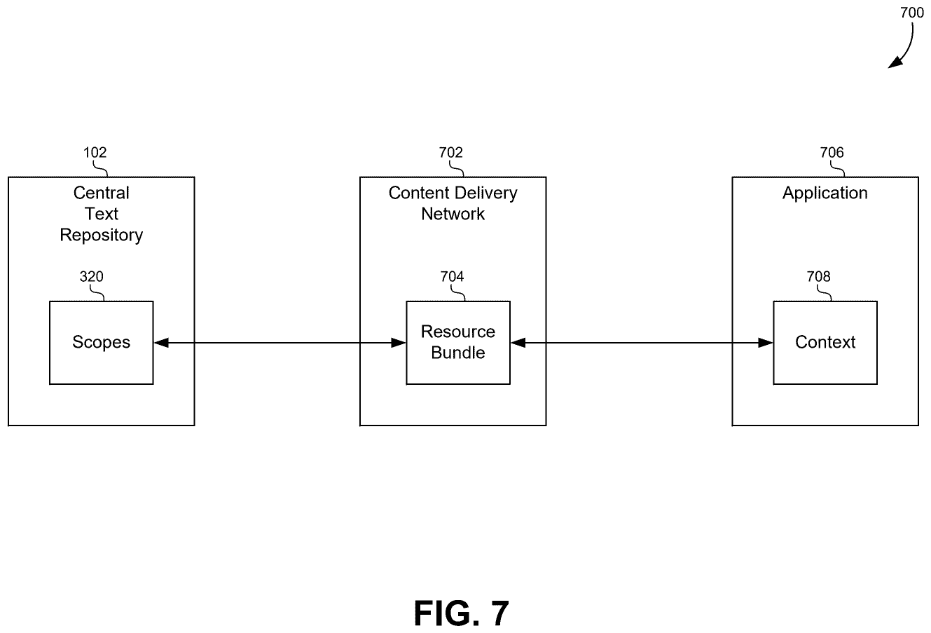

The method 200 may also include providing the one or more first string keys and the one or more second string keys to be accessible at runtime by the first context of the application (208). FIG. 7 illustrates a diagram 700 of a content delivery network 702 for delivering resource bundles from the central text repository 102 to the application 706, according to some embodiments. The central text repository 102 may generate each resource bundle as described above. For example, a given application may include a plurality of different contexts, and each context may be associated with an individual resource bundle, and each resource bundle may be associated with a corresponding scope in the scope data structure 320.

After these resource bundles are generated by the central text repository 102, these resource bundles may be uploaded to a content delivery network (CDN) 702. The CDN may be distributed with mirror locations in different geographic areas. Edge nodes of the CDN may store cached copies of the resource bundles such that they are in close proximity (e.g. geographically or measured latency) to where various computing environments are located that are operating the corresponding application 706. The CDN 702 may be adapted to efficiently store a large number of resource bundles that may be uploaded/downloaded rapidly on demand. This spreads the distribution of resource bundles out across the CDN 702. This may be contrasted with an architecture where applications request resource bundles directly from the central text repository 102. Instead of large simultaneous demand events meeting a bottleneck at the central text repository 102, these events may be easily handled by the distributed CDN 702.

As described above, the application 706 may operate in many different geographic locations and in different formats. The application 706 may request a resource bundle 704 from the CDN 702 at any time. For example, the application 706 may request a resource bundle 704 when the application 706 is installed, and this resource bundle 704 may be referenced each time the application 706 is executed. Alternatively, the application 706 may request the resource bundle 704 at runtime. For example, the application 706 may request all resource bundles used by the application 706 each time the application 706 is run. This ensures that the resource bundle 704 is always up-to-date with each execution of the application 706. In other embodiments, the application 706 may only request resource bundles when the corresponding context 708 is executed. For example, if the context 708 represents a dialog box for creating a new employee record, the application 706 may request the corresponding resource bundle for the context 708 when that context 708 is actually initiated by the application 706. This allows for a on-demand distribution of the resource bundles on an as-needed basis by the application 706. This may also reduce the bandwidth required for transmitting resource bundles when they are only transmitted when actually used by the application 706.

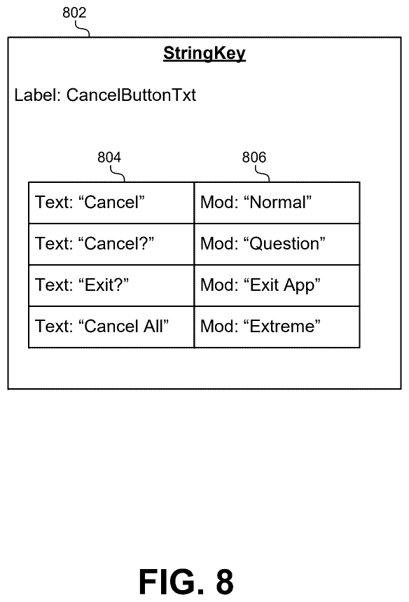

FIG. 8 illustrates a string key data structure that includes modifiers for the string text, according to some embodiments. An application may reference a resource bundle by including a URL for each scope. Even though the URL may be static in the code, the resource bundle itself may be continuously updated. Modifiers may be used as a way for versioning strings without changing the address of the URL for the resource bundle. This allows for improvements to user interface strings without the need for any modification of the code (e.g., fixing typos, improving translations, improving explanations, replacing placeholder text, etc.). Modifiers also allow for changes when the intent of the string changes. For example, a string field that was optional may become mandatory, new dependent functionalities may be added, or the meaning of the related data may change. While a new copy of the string key could be created with the text of the string key changed to reflect the new intent, this can be hard to implement and track. However, modifiers provide a more efficient means for updating strings without copying/replacing existing string keys.

Modifiers may be defined as short strings that are included with the translation request in the data structure. There can be an arbitrary number of modifiers that are defined at any level. For example, if the string key includes multiple translations with different modifiers, rather than returning a simple string the resource bundle, the string key may instead return a hash map or array of strings that are keyed by the modifiers. For example, the string key 802 in FIG. 8 may include an array of strings 804 that are keyed by modifiers 806. These can be added at any point to the individual string key data structures that are stored at the central text repository. When string and modifier combinations are added to a string key, the resource bundle may be regenerated and pushed out to the content delivery network.

When processing a string key from resource bundle, the application may determine the type of data structure present for each string key. If the string key includes a single string, then the application may simply display the single string. Alternatively, if the string key includes an array of strings, then the application may compare a modifier requirement of the application to the modifiers 806. The application may then select the string with a corresponding modifier that is a closest match to the modifier requirement of the application.

For example, a modifier may include a numbered version of the application. Since multiple versions of the application may operate simultaneously in different locations, both versions of a string may be needed in the resource bundle. If there is a need to deliver two versions of a string at once, a new modifier may be added to the string key definition. The application may then retrieve the resource bundle and select the string with a modifier that matches the version of the application at runtime.

Modifiers may also be used to adapt the user interface text to runtime changes in the application or behavior. For example, a platform application may alter the behavior of certain data fields based on runtime characteristics of the application. These characteristics may include a software configuration, whether other apps are installed in the system, user privileges, characteristics of the user (e.g. language, title, etc.), and so forth. Generally, any characteristic may be included as a modifier requirement. This is particularly useful when the resource bundle is retrieved, but the characteristics will not be known until runtime. This can be used to change the language, translation, or intent of the string based on runtime characteristics. When the application includes a modifier requirement in the code to display the string, that modifier can be used to select the closest match in the array of strings provided from the string key 802.

It should be appreciated that the specific steps illustrated in FIG. 2 provide particular methods of managing a central text repository according to various embodiments. Other sequences of steps may also be performed according to alternative embodiments. For example, alternative embodiments may perform the steps outlined above in a different order. Moreover, the individual steps illustrated in FIG. 2 may include multiple sub-steps that may be performed in various sequences as appropriate to the individual step. Furthermore, additional steps may be added or removed depending on the particular applications. Many variations, modifications, and alternatives also fall within the scope of this disclosure.

Each of the methods described herein may be implemented by a computer system. Each step of these methods may be executed automatically by the computer system, and/or may be provided with inputs/outputs involving a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Those steps not involving a user may be said to be performed automatically by the computer system without human intervention. Therefore, it will be understood in light of this disclosure, that each step of each method described herein may be altered to include an input and output to and from a user, or may be done automatically by a computer system without human intervention where any determinations are made by a processor. Furthermore, some embodiments of each of the methods described herein may be implemented as a set of instructions stored on a tangible, non-transitory storage medium to form a tangible software product.

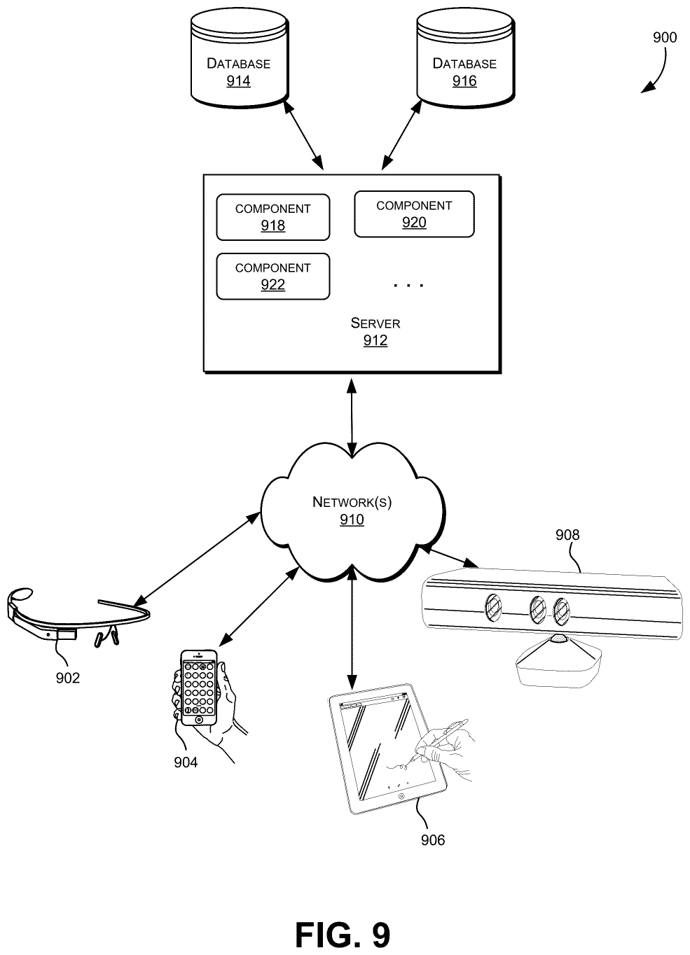

FIG. 9 depicts a simplified diagram of a distributed system 900 for implementing one of the embodiments. In the illustrated embodiment, distributed system 900 includes one or more client computing devices 902, 904, 906, and 908, which are configured to execute and operate a client application such as a web browser, proprietary client (e.g., Oracle Forms), or the like over one or more network(s) 910. Server 912 may be communicatively coupled with remote client computing devices 902, 904, 906, and 908 via network 910.

In various embodiments, server 912 may be adapted to run one or more services or software applications provided by one or more of the components of the system. In some embodiments, these services may be offered as web-based or cloud services or under a Software as a Service (SaaS) model to the users of client computing devices 902, 904, 906, and/or 908. Users operating client computing devices 902, 904, 906, and/or 908 may in turn utilize one or more client applications to interact with server 912 to utilize the services provided by these components.

In the configuration depicted in the figure, the software components 918, 920 and 922 of system 900 are shown as being implemented on server 912. In other embodiments, one or more of the components of system 900 and/or the services provided by these components may also be implemented by one or more of the client computing devices 902, 904, 906, and/or 908. Users operating the client computing devices may then utilize one or more client applications to use the services provided by these components. These components may be implemented in hardware, firmware, software, or combinations thereof. It should be appreciated that various different system configurations are possible, which may be different from distributed system 900. The embodiment shown in the figure is thus one example of a distributed system for implementing an embodiment system and is not intended to be limiting.

Client computing devices 902, 904, 906, and/or 908 may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 10, Palm OS, and the like, and being Internet, e-mail, short message service (SMS), Blackberry®, or other communication protocol enabled. The client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices 902, 904, 906, and 908 may be any other electronic device, such as a thin-client computer, an Internet-enabled gaming system (e.g., a Microsoft Xbox gaming console with or without a Kinect® gesture input device), and/or a personal messaging device, capable of communicating over network(s) 910.

Although exemplary distributed system 900 is shown with four client computing devices, any number of client computing devices may be supported. Other devices, such as devices with sensors, etc., may interact with server 912.

Network(s) 910 in distributed system 900 may be any type of network that can support data communications using any of a variety of commercially-available protocols, including without limitation TCP/IP (transmission control protocol/Internet protocol), SNA (systems network architecture), IPX (Internet packet exchange), AppleTalk, and the like. Merely by way of example, network(s) 910 can be a local area network (LAN), such as one based on Ethernet, Token-Ring and/or the like. Network(s) 910 can be a wide-area network and the Internet. It can include a virtual network, including without limitation a virtual private network (VPN), an intranet, an extranet, a public switched telephone network (PSTN), an infra-red network, a wireless network (e.g., a network operating under any of the Institute of Electrical and Electronics (IEEE) 802.11 suite of protocols, Bluetooth®, and/or any other wireless protocol); and/or any combination of these and/or other networks.

Server 912 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. In various embodiments, server 912 may be adapted to run one or more services or software applications described in the foregoing disclosure. For example, server 912 may correspond to a server for performing processing described above according to an embodiment of the present disclosure.

Server 912 may run an operating system including any of those discussed above, as well as any commercially available server operating system. Server 912 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle, Microsoft, Sybase, IBM (International Business Machines), and the like.

In some implementations, server 912 may include one or more applications to analyze and consolidate data feeds and/or event updates received from users of client computing devices 902, 904, 906, and 908. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 912 may also include one or more applications to display the data feeds and/or real-time events via one or more display devices of client computing devices 902, 904, 906, and 908.

Distributed system 900 may also include one or more databases 914 and 916. Databases 914 and 916 may reside in a variety of locations. By way of example, one or more of databases 914 and 916 may reside on a non-transitory storage medium local to (and/or resident in) server 912. Alternatively, databases 914 and 916 may be remote from server 912 and in communication with server 912 via a network-based or dedicated connection. In one set of embodiments, databases 914 and 916 may reside in a storage-area network (SAN). Similarly, any necessary files for performing the functions attributed to server 912 may be stored locally on server 912 and/or remotely, as appropriate. In one set of embodiments, databases 914 and 916 may include relational databases, such as databases provided by Oracle, that are adapted to store, update, and retrieve data in response to SQL-formatted commands.

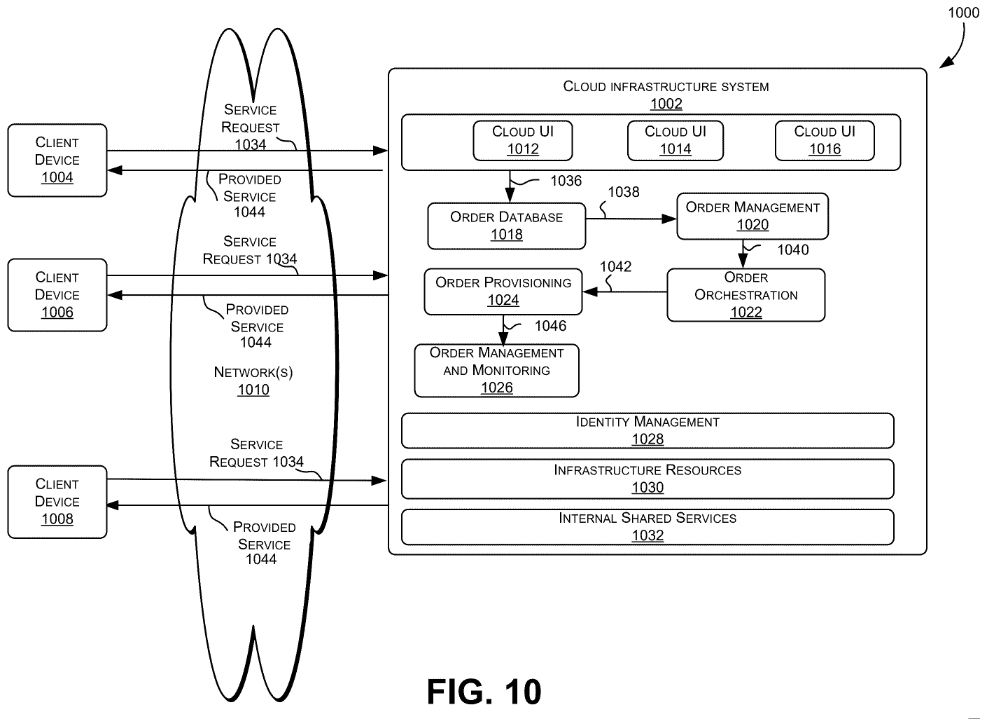

FIG. 10 is a simplified block diagram of one or more components of a system environment 1000 by which services provided by one or more components of an embodiment system may be offered as cloud services, in accordance with an embodiment of the present disclosure. In the illustrated embodiment, system environment 1000 includes one or more client computing devices 1004, 1006, and 1008 that may be used by users to interact with a cloud infrastructure system 1002 that provides cloud services. The client computing devices may be configured to operate a client application such as a web browser, a proprietary client application (e.g., Oracle Forms), or some other application, which may be used by a user of the client computing device to interact with cloud infrastructure system 1002 to use services provided by cloud infrastructure system 1002.

It should be appreciated that cloud infrastructure system 1002 depicted in the figure may have other components than those depicted. Further, the system shown in the figure is only one example of a cloud infrastructure system that may incorporate some embodiments. In some other embodiments, cloud infrastructure system 1002 may have more or fewer components than shown in the figure, may combine two or more components, or may have a different configuration or arrangement of components.

Client computing devices 1004, 1006, and 1008 may be devices similar to those described above for 902, 904, 906, and 908.

Although exemplary system environment 1000 is shown with three client computing devices, any number of client computing devices may be supported. Other devices such as devices with sensors, etc. may interact with cloud infrastructure system 1002.

Network(s) 1010 may facilitate communications and exchange of data between clients 1004, 1006, and 1008 and cloud infrastructure system 1002. Each network may be any type of network that can support data communications using any of a variety of commercially-available protocols, including those described above for network(s) 910.

Cloud infrastructure system 1002 may comprise one or more computers and/or servers that may include those described above for server 912.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 1002 may include a suite of applications, middleware, and database service offerings that are delivered to a customer in a self-service, subscription-based, elastically scalable, reliable, highly available, and secure manner. An example of such a cloud infrastructure system is the Oracle Public Cloud provided by the present assignee.

In various embodiments, cloud infrastructure system 1002 may be adapted to automatically provision, manage and track a customer's subscription to services offered by cloud infrastructure system 1002. Cloud infrastructure system 1002 may provide the cloud services via different deployment models. For example, services may be provided under a public cloud model in which cloud infrastructure system 1002 is owned by an organization selling cloud services (e.g., owned by Oracle) and the services are made available to the general public or different industry enterprises. As another example, services may be provided under a private cloud model in which cloud infrastructure system 1002 is operated solely for a single organization and may provide services for one or more entities within the organization. The cloud services may also be provided under a community cloud model in which cloud infrastructure system 1002 and the services provided by cloud infrastructure system 1002 are shared by several organizations in a related community. The cloud services may also be provided under a hybrid cloud model, which is a combination of two or more different models.

In some embodiments, the services provided by cloud infrastructure system 1002 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 1002. Cloud infrastructure system 1002 then performs processing to provide the services in the customer's subscription order.

In some embodiments, the services provided by cloud infrastructure system 1002 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations (such as Oracle) to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support. Examples of platform services include, without limitation, Oracle Java Cloud Service (JCS), Oracle Database Cloud Service (DBCS), and others.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services (e.g., Oracle Fusion Middleware services), and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 1002 may also include infrastructure resources 1030 for providing the resources used to provide various services to customers of the cloud infrastructure system. In one embodiment, infrastructure resources 1030 may include pre-integrated and optimized combinations of hardware, such as servers, storage, and networking resources to execute the services provided by the PaaS platform and the SaaS platform.

In some embodiments, resources in cloud infrastructure system 1002 may be shared by multiple users and dynamically re-allocated per demand. Additionally, resources may be allocated to users in different time zones. For example, cloud infrastructure system 1030 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 1032 may be provided that are shared by different components or modules of cloud infrastructure system 1002 and by the services provided by cloud infrastructure system 1002. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 1002 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 1002, and the like.

In one embodiment, as depicted in the figure, cloud management functionality may be provided by one or more modules, such as an order management module 1020, an order orchestration module 1022, an order provisioning module 1024, an order management and monitoring module 1026, and an identity management module 1028. These modules may include or be provided using one or more computers and/or servers, which may be general purpose computers, specialized server computers, server farms, server clusters, or any other appropriate arrangement and/or combination.

In exemplary operation 1034, a customer using a client device, such as client device 1004, 1006 or 1008, may interact with cloud infrastructure system 1002 by requesting one or more services provided by cloud infrastructure system 1002 and placing an order for a subscription for one or more services offered by cloud infrastructure system 1002. In certain embodiments, the customer may access a cloud User Interface (UI), cloud UI 1012, cloud UI 1014 and/or cloud UI 1016 and place a subscription order via these UIs. The order information received by cloud infrastructure system 1002 in response to the customer placing an order may include information identifying the customer and one or more services offered by the cloud infrastructure system 1002 that the customer intends to subscribe to.

After an order has been placed by the customer, the order information is received via the cloud UIs, 1012, 1014 and/or 1016.

At operation 1036, the order is stored in order database 1018. Order database 1018 can be one of several databases operated by cloud infrastructure system 1018 and operated in conjunction with other system elements.

At operation 1038, the order information is forwarded to an order management module 1020. In some instances, order management module 1020 may be configured to perform billing and accounting functions related to the order, such as verifying the order, and upon verification, booking the order.

At operation 1040, information regarding the order is communicated to an order orchestration module 1022. Order orchestration module 1022 may utilize the order information to orchestrate the provisioning of services and resources for the order placed by the customer. In some instances, order orchestration module 1022 may orchestrate the provisioning of resources to support the subscribed services using the services of order provisioning module 1024.

In certain embodiments, order orchestration module 1022 enables the management of business processes associated with each order and applies business logic to determine whether an order should proceed to provisioning. At operation 1042, upon receiving an order for a new subscription, order orchestration module 1022 sends a request to order provisioning module 1024 to allocate resources and configure those resources needed to fulfill the subscription order. Order provisioning module 1024 enables the allocation of resources for the services ordered by the customer. Order provisioning module 1024 provides a level of abstraction between the cloud services provided by cloud infrastructure system 1000 and the physical implementation layer that is used to provision the resources for providing the requested services. Order orchestration module 1022 may thus be isolated from implementation details, such as whether or not services and resources are actually provisioned on the fly or pre-provisioned and only allocated/assigned upon request.

At operation 1044, once the services and resources are provisioned, a notification of the provided service may be sent to customers on client devices 1004, 1006 and/or 1008 by order provisioning module 1024 of cloud infrastructure system 1002.

At operation 1046, the customer's subscription order may be managed and tracked by an order management and monitoring module 1026. In some instances, order management and monitoring module 1026 may be configured to collect usage statistics for the services in the subscription order, such as the amount of storage used, the amount data transferred, the number of users, and the amount of system up time and system down time.

In certain embodiments, cloud infrastructure system 1000 may include an identity management module 1028. Identity management module 1028 may be configured to provide identity services, such as access management and authorization services in cloud infrastructure system 1000. In some embodiments, identity management module 1028 may control information about customers who wish to utilize the services provided by cloud infrastructure system 1002. Such information can include information that authenticates the identities of such customers and information that describes which actions those customers are authorized to perform relative to various system resources (e.g., files, directories, applications, communication ports, memory segments, etc.) Identity management module 1028 may also include the management of descriptive information about each customer and about how and by whom that descriptive information can be accessed and modified.

FIG. 11 illustrates an exemplary computer system 1100, in which various embodiments may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that comprises software elements, shown as being currently located within a system memory 1110. System memory 1110 may store program instructions that are loadable and executable on processing unit 1104, as well as data generated during the execution of these programs.

Depending on the configuration and type of computer system 1100, system memory 1110 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1104. In some implementations, system memory 1110 may include multiple different types of memory, such as static random access memory (SRAM) or dynamic random access memory (DRAM). In some implementations, a basic input/output system (BIOS), containing the basic routines that help to transfer information between elements within computer system 1100, such as during start-up, may typically be stored in the ROM. By way of example, and not limitation, system memory 1110 also illustrates application programs 1112, which may include client applications, Web browsers, mid-tier applications, relational database management systems (RDBMS), etc., program data 1114, and an operating system 1116. By way of example, operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 1118 may also provide a tangible computer-readable storage medium for storing the basic programming and data constructs that provide the functionality of some embodiments. Software (programs, code modules, instructions) that when executed by a processor provide the functionality described above may be stored in storage subsystem 1118. These software modules or instructions may be executed by processing unit 1104. Storage subsystem 1118 may also provide a repository for storing data used in accordance with some embodiments.

Storage subsystem 1100 may also include a computer-readable storage media reader 1120 that can further be connected to computer-readable storage media 1122. Together and, optionally, in combination with system memory 1110, computer-readable storage media 1122 may comprehensively represent remote, local, fixed, and/or removable storage devices plus storage media for temporarily and/or more permanently containing, storing, transmitting, and retrieving computer-readable information.

Computer-readable storage media 1122 containing code, or portions of code, can also include any appropriate media, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1100.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, other ways and/or methods to implement the various embodiments should be apparent.

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have been described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, features are described with reference to specific embodiments thereof, but it should be recognized that not all embodiments are limited thereto. Various features and aspects of some embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMS, EPROMs, EEPROMs, magnetic or optical cards, flash memory, or other types of machine-readable mediums suitable for storing electronic instructions. Alternatively, the methods may be performed by a combination of hardware and software.

What is claimed is:

1. One or more non-transitory computer-readable media comprising instructions that, when executed by one or more processors, cause the one or more processors to perform operations comprising:
identifying a first scope in a plurality of scopes for an application, wherein the plurality of scopes are organized in a first hierarchy of parent-child relationships, and each of the plurality of scopes are associated with different contexts of the application;
determining one or more first string keys for the first scope that are a used by a first context of the application associated with the first scope;
identifying one or more second scopes in the plurality of scopes for which the first scope inherits one or more second string keys; and
providing the one or more first string keys and the one or more second string keys to be accessible at runtime by the first context of the application.

2. The one or more non-transitory computer-readable media of claim 1, wherein the parent-child relationships of the first hierarchy are organized such that the first context uses the one or more first string keys and the one or more second string keys when the application executes the first context.

3. The one or more non-transitory computer-readable media of claim 1, wherein the application comprises a plurality of contexts, and each of the plurality of contexts represents a distinct user interface provided by the application.

4. The one or more non-transitory computer-readable media of claim 1, wherein the plurality of scopes are also organized into a second hierarchy of parent-child relationships representing translations of the one or more first string keys and the one or more second string keys.

5. The one or more non-transitory computer-readable media of claim 4, wherein the operations further comprise determining a translation for each of the one or more first string keys by traversing the second hierarchy of parent-child relationships.

6. The one or more non-transitory computer-readable media of claim 4, wherein traversing the first hierarchy of parent-child relationships does not reach a root scope of the second hierarchy of parent-child relationships.

7. The one or more non-transitory computer-readable media of claim 4, wherein the operations further comprise determining a translation for each of the one or more first string keys by traversing the second hierarchy of parent-child relationships.

8. The one or more non-transitory computer-readable media of claim 4, wherein the second hierarchy of parent-child relationships represents child scope that can override a translation of a parent scope.

9. The one or more non-transitory computer-readable media of claim 1, wherein identifying the first scope in the plurality of scopes comprises determining that the first scope is exportable.

10. The one or more non-transitory computer-readable media of claim 1, wherein the operations are performed by a central text repository that is accessed by a plurality of applications operating in different computing environments and utilize the same plurality of scopes to generate string keys.

11. The one or more non-transitory computer-readable media of claim 10, wherein the different computing environments comprise computing environments operating in different languages, and the central text repository translates the one or more first string keys and the one or more second string keys into corresponding languages.

12. The one or more non-transitory computer-readable media of claim 1, wherein providing the one or more first string keys and the one or more second string keys comprises generating a resource bundle that includes all of the string keys and corresponding strings used by the first context of the application.

13. The one or more non-transitory computer-readable media of claim 12, wherein the application uses additional string keys that are not included in the resource bundle.

14. The one or more non-transitory computer-readable media of claim 12, wherein the operations further comprise sending the resource bundle to a content delivery network, such that the resource bundle is available for download by the application at runtime.

15. The one or more non-transitory computer-readable media of claim 1, wherein a string key in the one or more first string keys comprises a plurality of modifiers that identify different forms of a string associated with the string key.

16. The one or more non-transitory computer-readable media of claim 15, wherein the application selects a string with a corresponding modifier from the plurality of modifiers that best matches a corresponding modifier requirement at the application.

17. The one or more non-transitory computer-readable media of claim 1, wherein a string key in the first one or more string keys overrides a string key in the one or more second string keys.

18. The one or more non-transitory computer-readable media of claim 1, wherein determining the one or more first string keys for the first scope comprises identifying string keys store a link to the first scope.

19. A system comprising:
one or more processors; and
one or more memory devices storing instructions that, when executed by the one or more processors, cause the one or more processors to perform operations comprising:
identifying a first scope in a plurality of scopes for an application, wherein the plurality of scopes are organized in a first hierarchy of parent-child relationships, and each of the plurality of scopes are associated with different contexts of the application;
determining one or more first string keys for the first scope that are a used by a first context of the application associated with the first scope;
identifying one or more second scopes in the plurality of scopes for which the first scope inherits one or more second string keys; and
providing the one or more first string keys and the one or more second string keys to be accessible at runtime by the first context of the application.

20. A method comprising:
identifying a first scope in a plurality of scopes for an application, wherein the plurality of scopes are organized in a first hierarchy of parent-child relationships, and each of the plurality of scopes are associated with different contexts of the application;
determining one or more first string keys for the first scope that are a used by a first context of the application associated with the first scope;
identifying one or more second scopes in the plurality of scopes for which the first scope inherits one or more second string keys; and
providing the one or more first string keys and the one or more second string keys to be accessible at runtime by the first context of the application.
